(19) United States
(12) Patent Application Publication
(10) Pub. No.: US 2022/0010843 A1
(43) Pub. Date: Jan. 13, 2022

(54) UNIVERSAL JOINT FOR A STEERING SHAFT OF A MOTOR VEHICLE

(71) Applicants: thyssenkrupp Presta AG, Eschen (LI); thyssenkrupp AG, Essen (DE)

(72) Inventors: Maximilian EISWIRTH, Dornbirn (AT); Stefan FRICK, Sulz (AT)

(73) Assignees: thyssenkrupp Presta AG, Eschen (LI); thyssenkrupp AG, Essen (DE)

(21) Appl. No.: 17/294,440

(22) PCT Filed: Nov. 21, 2019
(86) PCT No.: PCT/EP2019/082141

§ 371 Date: May 17, 2021

(30) Foreign Application Priority Data
Nov. 23, 2018 (DE) 10 2018 220 180.3

(51) Int. Cl. F16D 3/38; B62D 1/16

(52) U.S. Cl. CPC F16D 3/385; B62D 1/16

(57) ABSTRACT

A universal joint may include a joint cross having two pairs of journals arranged at right angles to one another and two joint yokes that each have opposing arms. Each journal may be rotatably mounted in the opposing arms about a journal axis in a journal bearing that has a pot-shaped outer bushing that is fixed in the respective arms and that has an outer pot base disposed opposite an end side of the journal. A convexly projecting contact region may contact the outer pot base. Further, an inner bushing may be fixed on the journal, and rolling bodies may be disposed between the inner bushing and the pot-shaped outer bushing. The convexly projecting contact region may project axially on the end side relative to a surface of the inner bushing that acts as a raceway for the rollable rolling bodies.

### PRIOR ART

The invention relates to a universal joint for a steering shaft of a motor vehicle, comprising a joint cross having two pairs of journals, which are arranged at right angles to one another, and two joint yokes which can be connected to the steering shaft and which each have two mutually opposite arms in each of which a journal is mounted rotatably about a journal axis in a journal bearing which has a pot-shaped outer bushing which is fixed in the arm and which has an outer pot base situated opposite to the end side of the journal, wherein rollable rolling bodies are arranged between the journal and the outer bushing, and wherein a convexly projecting contact region, which contacts the outer pot base, is arranged on the end side of a journal.

In a motor vehicle, the steering shaft serves for transmitting the steering torque, which is introduced into the steering wheel, via the steering spindle and the intermediate shaft into the steering gear. To compensate for angular offset, within the course of the steering shaft there is incorporated at least one, usually two, universal joints, usually between the steering spindle and intermediate shaft and between the intermediate shaft and steering gear.

In terms of basic design, each joint has two joint yokes which are each mounted on a shaft end and which each have two arms extending in the shaft direction and which are situated opposite to one another transversely with respect to the shaft axis. A joint cross has two pairs of oppositely radially projecting joint journals, referred to as journals for short, which are arranged on journal axes crossing at right angles. The two journals of a pair are each mounted in an arm of a joint yoke in a journal bearing so as to be rotatable about their journal axis, which extends transversely with respect to the shaft axis through the arms. The journal bearings are designed as radial rolling bearings, usually as radial needle bearings.

The joint cross has a basic body which, to securely take up the high forces that occur, is preferably formed as a steel cold-pressed part or from another high-strength material, as described in the prior art in DE 10 2014 116 271 A1, for example. It is proposed therein for the radial bearings that the needles roll between rolling body raceways which, on the outside, are formed directly on the journal of the basic body and, on the inside, in an outer bushing connected to the arm. The outer bushing is formed with a pot shape as an outer pot which is fixed in an arm and in which the journal engages, with the result that the latter has its end side situated opposite the base of the outer bushing, i.e. the outer pot base.

In order during operation to achieve optimally play-free running and an optimally high stiffness of the joint arrangement, it is proposed in the aforementioned DE 10 2014 116 271 A1 to axially preload the bearing. This is achieved by the journal having a convex end side which, under elastic preloading, lies against the outer pot base of the outer bushing with a sliding action in a contact region. Elastically deforming the outer pot base in the axial direction of the journal axis in the outward direction causes the outer bushing to permanently exert an elastic preloading force on the journal pair.

The axial preloading allows the stiffness to be effectively increased in an advantageous manner. However, high-precision machining of the journals in the region of the rolling body raceways is required, which is complicated. In addition, the convex end side causes the axial region of the journal that is available for the rolling bearing raceway to be shortened, that is to say for the width of the rolling body raceway to be reduced, with the result that the admissible bearing loading of the journal bearing is limited. In order to increase the admissible bearing loading, the journal could indeed be lengthened in the axial direction, but the lengthening of the journals that is possible in principle is limited by the given distance between the arms of the joint yokes, since the insertion of the joint cross into the joint yokes is made more difficult or impossible as a result of an increasing length of the journals.

A similar joint arrangement is described in DE 10 2009 016 169 B4, in which a centering element is elastically braced axially between the end side of the journal and the outer pot base. This likewise results in the axial region of the journal that can be used as rolling body raceway being shortened and in the bearing loading being limited.

In view of the problem explained above, it is an object of the present invention to make available a joint arrangement that allows higher bearing loading with preloaded bearing of a joint cross.

### SUMMARY OF THE INVENTION

This object is achieved according to the invention by a universal joint having the features of claim 1. Advantageous developments will emerge from the dependent claims.

According to the invention, what is proposed, for a universal joint for a steering shaft of a motor vehicle, comprising a joint cross having two pairs of journals, which are arranged at right angles to one another, and two joint yokes which can be connected to the steering shaft and which each have two mutually opposite arms in each of which a journal is mounted rotatably about a journal axis in a journal bearing which has a pot-shaped outer bushing which is fixed in the arm and which has an outer pot base situated opposite to the end side of the journal, wherein rollable rolling bodies are arranged between the journal and the outer bushing, and wherein a convexly projecting contact region, which contacts the outer pot base, is arranged on the end side of a journal, is that an inner bushing is fixed on the journal, wherein the rolling bodies are arranged between the inner bushing and the outer bushing, and the contact region projects axially on the end side relative to the inner bushing.

Preferably, the convexly projecting contact region of the journal contacts the inner bushing, particularly preferably the base of the inner bushing.

The outer bushing is, as is known per se, formed as an outer pot, in which a hollow-cylindrical, tubular outer sleeve is closed at the end side by an outer pot base.

The inner bushing has a hollow-cylindrical, tubular sleeve, i.e. the inner sleeve, which is preferably nonreleasably fastened coaxially on the journal, for example by being pressed on, with the result that a firm and rigid force-fitting connection is produced. Additionally or alternatively, the connection can be configured as a substance-to-substance bonded connection, for example by means of adhesive bonding, and, additionally or alternatively, as a form-fitting connection, for example by caulking the sleeve on the journal, or by means of inter-engaging form-fitting structures, such as knurled or roughened formations, which during pressing-on can also be nonreleasably connected to one another by plastic deformation. By virtue of the fact that the connection is rigid, the inner bushing is fixed radially and axially immovably on the journal and thus unambiguously positioned.

On its radial outer side, the sleeve has an outer cylindrical lateral surface which, over its axial width, as measured in the direction of the journal axis, can be used as a rolling body raceway. Preferably, the inner bushing can be manufactured from rolling bearing steel, and at least partially hardened in the region of the rolling body raceway and/or provided with a hard coating, thereby ensuring low-play, smooth and low-wear running of the rolling bearing.

A particular advantage results from the fact that the contact region of the combination according to the invention of the inner bushing with the journal projects axially on the end side, that is to say as viewed from the inner bushing in the direction of the journal axis, relative to the inner bushing. Here, the convex contact region projects on the end side in particular beyond the region of the inner bushing that is formed as rolling body raceway. Whereas in the prior art the region on the journal that can be used as rolling body raceway is axially shortened as a result of the forming operation on the journal to realize the convex contact region, it is possible by means of the invention that, on such a journal, by virtue of the inner bushing, there can be realized a rolling body raceway having a larger width in the axial direction than would be possible by means of a rolling body raceway arranged directly on the journal. The sleeve of the inner bushing, the axial width of which determines the maximum axial width of the rolling body raceway, can have a larger dimension in the direction of the journal axis than the cylindrical outer circumference of the journal that can potentially be used as rolling body raceway. Here, the sleeve of the inner bushing can extend in the axial direction up and into the convexly converging region on the end side of the journal, wherein the contact surface projects beyond the rolling body raceway at the axially outermost point in the axial direction. As a result, for a given length of a journal having a convex contact surface on the end side, a higher admissible bearing loading can be achieved.

It is possible that the inner bushing is designed as an inner sleeve in the form of a tube portion and axially open on both sides and having its end-side end situated in a convex region of the journal. Here, the contact surface formed on the end side by convex forming of the journal projects axially on the end side out of the inner bushing and contacts the outer pot base directly or via a gap. In this way, the advantages of a journal having a convex end can be combined with the advantages of an inner bushing, with it being possible, as additional synergistic effect, to increase the width of the rolling body raceway in order to produce a higher admissible bearing loading.

The outer pot base and the convexly projecting contact region of the journal are preferably spaced apart by a gap, with contact between the journal and outer pot base occurring at least temporarily.

An advantageous embodiment of the invention provides for the inner bushing to be formed with a pot shape as an inner pot having an end-side inner pot base which has the contact region. The inner pot has a hollow-cylindrical sleeve which, as described above, has the rolling body raceway, and which is closed by the inner pot base on the end side. The inner pot is put axially onto the journal by way of its opening, also referred to as pot opening, that faces away from the end side.

The outer pot base and the convexly projecting contact region of the journal preferably come into direct contact only as soon as when the inner bushing is deformed in the direction of the outer bushing. This results in better radial support and in better force transmission.

The contact between the journal and outer pot base and/or between the journal and inner pot base and/or between the end side of the inner pot base and outer pot base can preferably occur simultaneously, with the result that there can be temporarily double contact present.

Unlike in the prior art, the contact region is not formed on the basic body of the journal itself, but rather on the inner bushing mounted on the journal. This results in the advantage already described above that the axial width which can be used as rolling body raceway can be increased. A further advantage is that there are wider possibilities available for configuring and functionally optimizing the contact region. For example, the inner bushing is, by comparison with a solid journal, more easily able to be shaped and formed, for example by being produced as a thin-walled shaped steel sheet part which can be produced by pressing, deep-drawing and other known cold-forming and hot-forming methods in an efficient and precise manner, wherein the local wall thickness and individually adapted designs of the sleeve and pot base can be predefined with a large degree of design freedom. The contact region can be realized, for example, by plastically pressing in the inner pot base, this requiring less manufacturing effort than the formation of a convex end side of a solid journal.

The contact region is arranged centrally on the journal axis and is smaller than the open inner cross section of the inner bushing, which corresponds substantially to the cross section of the journal.

Furthermore, the material selection can occur independently of the material of the journal. As described above, for example, a partial hardening can occur in the region of the sleeve to optimize the rolling body raceway. In the region of the pot base there can likewise be provided a partial hardening, surface configuration, coating or the like in order, in the contact region, to reduce the sliding friction in the contact with the outer bushing. As a result, the contact region can, with regard to its shape and its functional properties, be more simply optimized than is possible with the shaping of the journal itself.

In addition, it is possible for the first time to realize elastic properties of the inner bushing for preloading the joint cross in the joint yoke, as will be explained below.

It is preferably possible for the contact region on the inner pot to be designed to be axially resilient. The contact region is shaped so as to project convexly on the end side outwardly, that is to say in the direction of the journal axis, from the pot base. By means of an adapted shaping, material configuration and wall thickness, the inner bushing can be configured to be intrinsically axially elastic, with the result that the contact region arranged on the pot base is, with respect to the sleeve fastened on the journal, sprung with regard to pressure on the end face relative to the journal. By contrast with the prior art, the inner bushing itself forms a spring element which acts in the direction of the journal axis and which is connected to the journal and which allows the braced bearing of the joint cross between the arms of the joint yoke. Therefore, according to the invention, the inner pot has a multiple function, namely increasing the rolling body raceway, as carrier of the contact region and as spring element for elastically bracing the joint cross in the joint yoke.

The axial elasticity of the inner bushing can be achieved by virtue of the inner pot base being connected to the sleeve in an axially resilient manner, for example by means of a flat formation or a peripheral bead.

An advantageous embodiment is that the contact region is formed by a spherical cap formed on the inner pot base. Here, the inner pot base can be designed to be at least 50%, preferably 75% to 80%, planar, that is to say flat, outside of the contact region. The convex shape is provided by the spherical cap which projects convexly outwardly from the end side and which can be realized, for example, as a formation in the form of a portion of a sphere, which can also be flattened in the region of the central contact surface, or can have a frustoconical shape. The spherical cap can be a plastic formed-in portion which is incorporated from the inside into the otherwise planar pot base, which is substantially planar transversely with respect to the journal axis, said formed-in portion being produced by means of pressing, for example. The spherical cap extends centrally only over a subregion of the pot base, and is preferably surrounded and held by the flat annular region of the pot base that remains outside of the contact region. The spherical cap is intrinsically relatively dimensionally stiff, with the result that there is advantageously made available a uniform defined size of the contact surface with the outer bushing. The flat annular region surrounding the spherical cap can form a spring element, which allows an elastic displacement of the spring cap relative to the sleeve, and thus produces the resilient arrangement of the contact surface relative to the journal. The spherical cap is preferably formed in one piece with the inner bushing. Furthermore, it is conceivable and possible for the contact surface to adopt a corrugated structure in order thus to allow an improved action of force.

The spring constant of the spring element can be predetermined by the material thickness and the relative ratio of the dimensions of the spherical cap and flat region of the pot base. To provide sufficient elasticity, it is advantageous for the contact region to be designed to be at least 50% flat, preferably 75% to 80%, with the result that a higher degree of elasticity can be produced.

It is also conceivable that, additionally or alternatively, axially elastically deformable regions are provided in the pot base or in the sleeve, for example by means of bead-shaped or corrugated formed-in portions, material thinning's or the like.

There can be provision that the inner pot base has an axial spacing from the end side of the journal. There is thus provided a free spring region into which the pot base, at least in the contact region, can spring in axially against the end side of the journal if the journals have been inserted under preloading between the arms of the joint yoke. The spacing can be dimensioned in such a way that there can occur elastic deformation of the inner bushing that is sufficient to produce a predetermined preloading force.

An advantageous embodiment of the invention provides for the outer pot base to be designed to be flat. The contact region, which is formed according to the invention on the journal, or preferably on the inner bushing, is supported from the inside on the outer pot base of the pot-shaped outer bushing so as to be rotatable about the journal axis. By virtue of the fact that the outer pot base is flat in the contact region at least on its inner side facing the end side of the journal, a defined contact and bearing surface is made available. The outer pot having the flat outer pot base can be produced efficiently with the required stiffness. The flat outer pot base has predominantly an axial supporting function, and is also not substantially deformed by the preloading force introduced via the contact regions. This is advantageous insofar as, on the one hand, the outer shape does not change as a result of the preloading force and, on the other hand, possible external effects have no influence on the preloading force.

The contact region can have a centering prong which projects centrally on the end side and which engages in a centering depression in the outer bushing. As a result, the coaxially centered bearing of the journal or of the inner bushing relative to the outer bushing can be ensured with regard to a rotation about the journal axis.

There can be provision that the inner bushing has an outwardly projecting flange portion. The flange portion can be designed in the form of a collar running around in the edge region of the rear opening of the inner bushing in which the journal engages. It is possible by means of the flange portion for an axial sealing surface to be made available against which an elastic sealing element can lie sealingly for the purpose of sealing with respect to the outer bushing.

It is possible furthermore for the outer pot to have a radially projecting holding projection. The holding projection can preferably project inwardly from the outer sleeve in the edge region of the opening of the outer pot, and engage around and hold the rolling bodies. Furthermore, a sealing element, for example a sealing ring, for sealing the bearing interior in which the rolling bodies are situated can be arranged between the sealing surfaces on the holding projection and on an outwardly projecting flange portion of the inner bushing.

Preferably, the inner bushing can be connected to the journal, and/or the outer bushing can be connected to the arm, in a force-fitting manner and/or form-fitting manner and/or with substance-to-substance bonding. A force-fitting connection can occur by pressing the inner bushing onto the journal or by pressing the outer bushing into an opening of the yoke. To produce a form-fitting connection, it is possible, for example by means of caulking, for there to be produced a local plastic deformation against which the inner or outer bushing is supported on the journal or the yoke. Substance-to-substance bonding can comprise adhesive bonding, welding or the like.

### DESCRIPTION OF THE DRAWINGS

Advantageous embodiments of the invention will be explained in more detail below with reference to the drawings, in which in detail:

FIG. 1 shows a steering column in a schematic perspective view,

FIG. 2 shows a universal joint of a steering column according to FIG. 1 in a schematic perspective view,

FIG. 3 shows a longitudinal section through a journal bearing according to the invention of a universal joint according to FIG. 2 in a first embodiment,

FIG. 4 shows a longitudinal section through a journal bearing according to the invention of a universal joint according to FIG. 2 in a second embodiment,

FIG. 5 shows a longitudinal section through a journal bearing according to the invention of a universal joint according to FIG. 2 in a third embodiment,

FIG. 6 shows a longitudinal section through a journal bearing according to the invention of a universal joint according to FIG. 2 in a fourth embodiment,

FIG. 7 shows a longitudinal section through a journal bearing according to the invention of a universal joint according to FIG. 2 in a fifth embodiment,

FIG. 8 shows a partially exploded illustration of the universal joint according to FIG. 2 in the first embodiment according to FIG. 3,

FIG. 9 shows a longitudinal section through a journal bearing according to the invention of a universal joint according to FIG. 2 in a sixth embodiment,

FIG. 10 shows a partially exploded illustration of the universal joint according to FIG. 7,

FIG. 11 shows a partially exploded illustration of the universal joint according to FIG. 5.

### EMBODIMENTS OF THE INVENTION

In the various figures, identical parts are always provided with the same reference signs and are therefore as a rule also in each case only named or mentioned once.

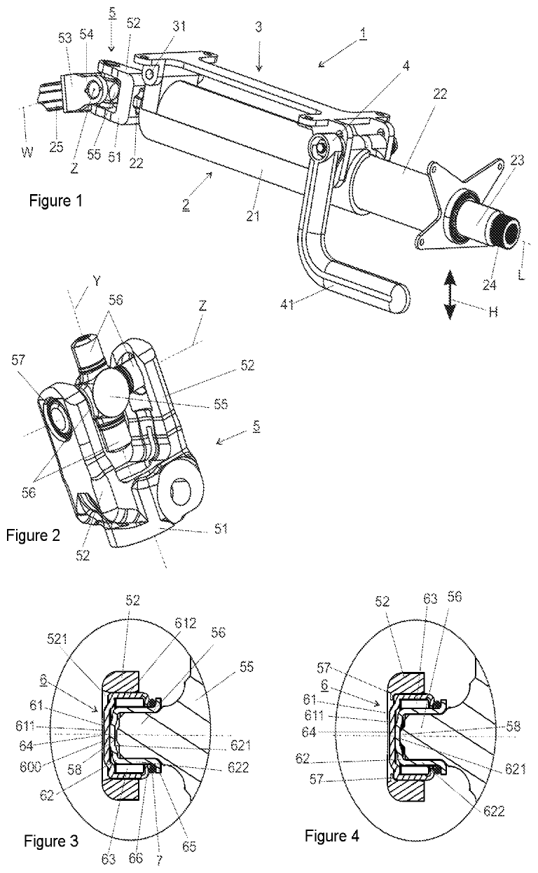

FIG. 1 shows a steering column 1 according to the invention schematically in a perspective view obliquely from behind (with respect to the direction of travel of a motor vehicle that has not been shown).

The steering column 1 comprises an adjustment unit 2, having a casing unit 21, in which a casing tube 22 is received. A steering spindle 23 is mounted in the casing unit 21 so as to be rotatable about a longitudinal axis L. The steering spindle 23 forms a rear or upper part of the steering shaft and has at its rear end a connection portion 24 for a steering wheel (not shown).

The adjustment unit 2 is mounted in its front region on a carrier unit 3, which can be fitted to a body (not shown) of a motor vehicle, in a pivot bearing 31 so as to be pivotable about a horizontal pivot axis, with the result that, to adjust the height of the steering wheel in the region of the connection portion 24, the steering spindle 23 is pivotable in a height direction H.

In the rear region of the adjustment unit 2 there is situated, at a distance from the pivot bearing 31, a clamping device 4 which, by actuating a clamping lever 41, makes it possible for the adjustment unit 2 to be releasably clamped with the carrier unit 2 in order to fix the set height adjustment. By releasing the clamping device 4, it is furthermore possible, for the purpose of the length adjustment, to adjust the casing tube 22 telescopically relative to the casing unit 21. Upon fixing of the clamping device 4, the casing tube 22 is likewise releasably clamped in the casing unit 21, thereby fixing the length setting.

At its front end projecting out of the casing unit 21 in FIG. 1 to the left, the steering spindle 22 is coupled in an articulated manner, via a universal joint 5, to an intermediate shaft 52 which is rotatable about a shaft axis W inclined with respect to the longitudinal axis L.

The joint 5 has a first joint yoke 51, which is fixedly connected to the steering spindle 22 and which has two arms 52 situated opposite to one another with respect to the longitudinal axis L. A joint yoke 53 of identical design is mounted on the intermediate shaft 25 and has two arms 54 situated opposite to one another with respect to the shaft axis W.

The joint yokes 51 and 53 are connected to one another in an articulated manner via a joint cross 55, also referred to as a journal cross.

FIG. 2 illustrates the joint 5 on an enlarged scale, with only the joint yoke 51 being depicted for the sake of better clarity. The joint cross 55 has two pairs of oppositely radially projecting journals 56, also referred to as joint journals, which are arranged on journal axes Z and Y crossing at right angles. The two journals 56 of a pair are each mounted in a journal bearing 6 in an arm 52, 54 of a joint yoke 51, 53 so as to be rotatable about their respective journal axes Z and Y, which extend transversely with respect to the longitudinal axis L or to the shaft axis W through the arms 52 and 54.

Since the invention relates to the design of the journal bearings 6, and the first arrangement in the arms 52 of the yoke 51 is substantially identical to the second arrangement in the arms 54 of the joint yoke 53, only the reference signs of the first arrangement will be mentioned below, with the second arrangement being analogously covered thereby.

FIG. 3 shows a section along the journal axis Z through the joint cross 55. It can be seen therein that the journal 56 is formed in one piece with a basic body of the joint cross 55, which is preferably manufactured as a steel cold-pressed part.

The journal bearing 6 has an outer bushing in the form of an outer pot 61 having a substantially flat outer pot base 611 which closes a cylindrical outer sleeve 612 on the end side. The outer sleeve 612 is fixedly connected to the arm 52, for example being pressed into an opening 521.

An inner bushing in the form of an inner pot 62 has a tubular inner sleeve 622 which is fixedly mounted on the journal 56, for example by being pressed on, and which is closed on the end side by an inner pot base 621, and, on the other hand, in the non-preloaded state, is axially spaced apart, by means of a gap 600, from the end side of the journal 56, beyond a projection 58 of the journal 56 that serves as a contact region.

The journal bearing 6 takes the form of a radial rolling bearing, with the rolling body 63 being constituted by cylindrical needles which are arranged such that they are able to roll between the rolling body raceways formed on the inner lateral surface of the outer sleeve 612 and the outer lateral surface of the inner sleeve 622.

The inner pot base 621 has on the end side a convexly projecting contact region 64 which lies from the inside against the outer pot base 611. In the example shown, the contact region 64 takes the form of a frustoconical spherical cap which is connected by the inner pot base 621 to the inner sleeve 622 so as to be axially spring-elastic in the direction of the journal axis Z. As a result, the contact region 64 can spring in axially elastically in the direction of the journal axis Z, counter to the spring force exerted by the inner pot base 621, against the end side of the journal 56, thereby making it possible for the journal 56 to be braced elastically against the outer pot base 611 in the direction of the journal axis Z.

In the illustration of FIG. 3, the joint cross 55 is pressed to the right by the spring force exerted by the axially elastic inner pot 62 via the contact region 64, with the result that the joint cross 55 is in direct contact by way of its end side, in particular via the projection 58, with the inner pot base 621. By virtue of the journal bearing formed in mirror-image fashion thereto on the other, opposite journal 56 of the pair, a spring force of equal size, directed to the left, is correspondingly exerted, with the result that the joint cross is braced elastically between the arms 52 of the joint yoke 51 by this spring force.

An elastomer sealing ring 7, which axially between a flange 65, which projects radially outward in the manner of a collar, on the inner sleeve 622 and a holding projection 66, which projects inwardly from the outer sleeve 612, serves to seal to the outside the interior of the journal bearing 6 that receives the needles 63.

FIG. 8 shows the individual constituent parts in isolation in an exploded view.

FIG. 4 shows an embodiment as in FIG. 3, in which the arm 52 has the caulkings 57, which form plastic deformations for fixing the outer pot 61 in the opening 521 in a form-fitting manner, and, unlike FIG. 3, shows a preloaded journal bearing 6.

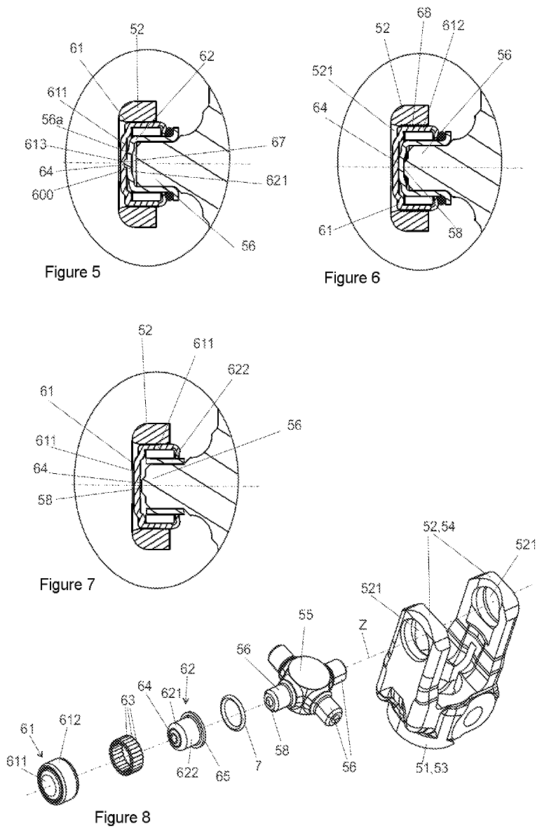

The embodiment shown in FIG. 5 corresponds in principle to the embodiment according FIG. 3 or 4. In this case, the inner pot 62 additionally has, on the inner pot base 621, in the region of the contact surface, a central centering prong 67 which projects axially on the end side and which is mounted in a corresponding depression 613 so as to be rotatable about the journal axis Z. The end side of the journal is axially spaced apart from the inner pot base 621 via the gap 600. The centering prong 67 acts as a contact region with the outer pot base 611.

FIG. 11 shows the individual constituent parts in isolation in an exploded view. What is illustrated here is that at least one journal 56 has a flat or planar contact surface 56a onto which the inner bushing 62 is pressed.

FIG. 6 shows a possible development of the embodiments illustrated in FIG. 3, 4 or 5, in which development connecting means 68, for example form-fitting elements such as knurled or roughened formations or the like, are arranged in the region of the connecting surface between the arm 52 and the outer pot 61 on the inner surface of the opening 521 and/or on the outer surface of the outer pot 61.

In the alternative embodiment according to FIG. 7, the inner bushing 62 takes the form of an inner sleeve 622 which is open on both sides and which thus has no inner pot base on the end side. In this case, the convexly projecting contact region 64 is arranged on a projection 58 of the journal 56 that projects centrally on the end side. The projection 58 is formed integrally on the journal 56 and projects out of the inner sleeve 622 on the end side and lies against the outer pot base 611. Here, the outer pot base 611 can be designed to be axially spring-elastic in the direction of the journal axis Z.

FIG. 10 shows the individual constituent parts in isolation in an exploded view. The projection 58 of the journal 56 serves as centering means for the outer bushing 61.

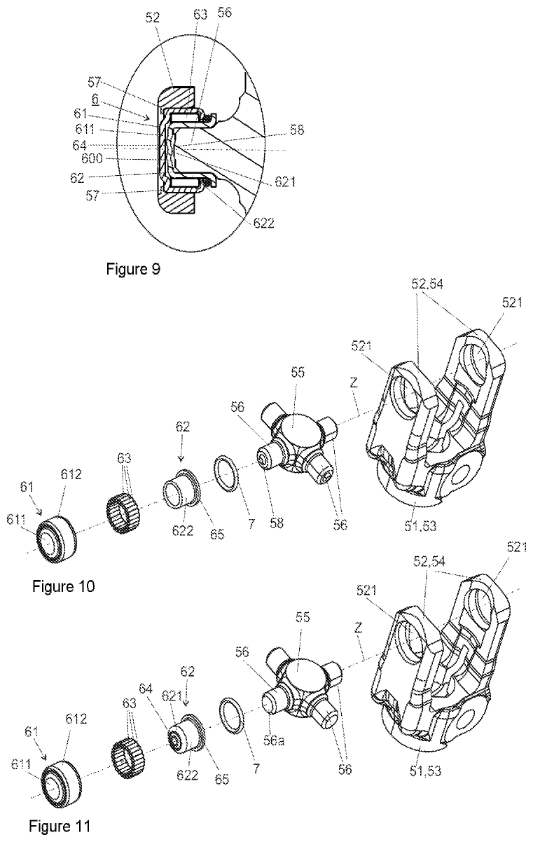

FIG. 9 shows a possible development of the embodiments illustrated in FIG. 3, 4 or 5, wherein, on the one hand, the inner pot base 621 is spaced apart axially from the projection 58 of the journal 56 via a gap 600 and, on the other hand, lies against the outer pot base 611. The pot base of the inner pot 62 is designed to be corrugated and, in the preloading state, lies both against the outer pot base 611 and against the projection 58 of the journal.

### LIST OF REFERENCE SIGNS

1 Steering column
2 Adjustment unit
21 Casing unit
22 Casing tube
23 Steering spindle
24 Connection portion
25 Intermediate shaft
3 Carrier unit
31 Pivot bearing
4 Clamping device
41 Clamping lever
5 Universal joint
51, 53 Joint yokes
52, 54 Arm
521 Opening
55 Joint cross (journal cross)
56 Journal (joint journal)
57 Caulking
58 Projection
6 Journal bearing
61 Outer pot
611 Outer pot base
612 Outer sleeve
613 Depression
62 Inner pot
621 Inner pot base
622 Inner sleeve
63 Rolling body
64 Contact region
65 Flange
66 Holding projection
67 Centering prong
68 Connecting means
7 Sealing ring
L Longitudinal axis
W Shaft axis
Z, Y Journal axis

1-11. (canceled)

12. A universal joint for a steering shaft of a motor vehicle, the universal joint comprising:
a joint cross having two pairs of journals that are arranged at right angles to one another; and
two joint yokes that are connectable to the steering shaft, each joint yoke having two mutually opposite arms,
wherein in each of the arms one of the journals is rotatably mounted about a journal axis in a journal bearing, wherein each journal bearing includes a pot-shaped outer bushing that is fixed in the respective arm and has an outer pot base disposed opposite an end side of the respective journal, wherein each outer pot base is contacted by a convexly projecting contact region, wherein an inner bushing is fixed on each journal, wherein in each case rollable rolling bodies are disposed between the inner bushing and the pot-shaped outer bushing, wherein the convexly projecting contact region projects axially relative to a portion of the inner bushing that acts as a raceway for the rolling bodies.

13. The universal joint of claim 12 wherein the inner bushing is pot shaped with an inner pot having an end-side inner pot base that includes the convexly projecting contact region.

14. The universal joint of claim 13 wherein the convexly projecting contact region disposed on the inner pot is axially resilient.

15. The universal joint of claim 13 wherein the convexly projecting contact region is configured as a spherical cap disposed on the end-side inner pot base.

16. The universal joint of claim 15 wherein the end-side inner pot base is at least 50% planar outside of the convexly projecting contact region.

17. The universal joint of claim 15 wherein the end-side inner pot base is axially spaced apart from the end side of the journal.

18. The universal joint of claim 12 wherein the outer pot base is flat.

19. The universal joint of claim 12 wherein the inner bushing includes an outwardly projecting flange portion.

20. The universal joint of claim 12 wherein the pot-shaped outer bushing includes a radially projecting holding portion.

21. The universal joint of claim 12 comprising a sealing element disposed between the pot-shaped outer bushing and the inner bushing.

22. The universal joint of claim 12 wherein the inner bushing is connected to the journal by or in at least one of
a force-fitting manner,
a form-fitting manner, or
substance-to-substance bonding.

23. The universal joint of claim 12 wherein the pot-shaped outer bushing is connected to the arm by or in at least one of
a force-fitting manner,
a form-fitting manner, or
substance-to-substance bonding.

24. A universal joint comprising:
a joint cross having two pairs of journals that are arranged at right angles to one another; and
two joint yokes, each joint yoke having opposing arms,
wherein in each arm one of the journals is rotatably mounted about a journal axis in a journal bearing, wherein each journal bearing includes a pot-shaped outer bushing that is fixed in the respective arm and has an outer pot base disposed opposite an axial end side of the respective journal, wherein each outer pot base is contacted by a convexly projecting contact region of an inner bushing that is fixed on each journal, wherein in each case a rollable rolling body is disposed between the inner bushing and the pot-shaped outer bushing, wherein the convexly projecting contact region protrudes axially relative to the rolling body.

25. The universal joint of claim 24 wherein the convexly projecting contact region protrudes axially relative to a portion of the inner bushing that acts as a raceway for the rolling body.

26. The universal joint of claim 24 wherein the inner bushing is pot shaped with an inner pot having an end-side inner pot base that includes the convexly projecting contact region.

27. The universal joint of claim 26 wherein the convexly projecting contact region disposed on the inner pot is axially resilient.

28. The universal joint of claim 26 wherein the convexly projecting contact region is configured as a spherical cap disposed on the end-side inner pot base.

29. The universal joint of claim 24 wherein a surface area of the end-side inner pot base outside of the convexly projecting contact region is at least 50% planar.

30. The universal joint of claim 24 wherein the end-side inner pot base is axially spaced apart from the axial end side of the journal at a center of the end-side inner pot base.

31. The universal joint of claim 24 comprising a sealing element disposed between the pot-shaped outer bushing and the inner bushing.
